(19) United States
(12) Patent Application Publication
(10) Pub. No.: US 2019/0353949 A1
(43) Pub. Date: Nov. 21, 2019

(54) ELECTRONIC WRITING BOARD

(71) Applicant: Triple Power Limited, Taipei City (TW)

(72) Inventor: Fu-Ming WANG, Taipei City (TW)

(21) Appl. No.: 16/393,667

(22) Filed: Apr. 24, 2019

(30) Foreign Application Priority Data
May 15, 2018 (TW) 107116425

(51) Int. Cl. G02F 1/137; G02F 1/1333; G06F 3/033

(52) U.S. Cl. CPC G02F 1/13718; G02F 1/13338; G09G 2300/0486; G02F 2001/133302; G06F 3/033

(57) ABSTRACT

An electronic writing board comprises a first glass substrate, a second glass substrate and a Cholesteric liquid crystal layer. The first glass substrate has a writing surface, and the thickness thereof is between 0.1 mm and 0.35 mm. The second glass substrate is disposed opposite to the first glass substrate. The Cholesteric liquid crystal layer is disposed between the first glass substrate and the second glass substrate. The electronic writing board has a novel structure and can be easily manufactured, thereby reducing the cost of production machines.

### CROSS REFERENCE TO RELATED APPLICATIONS

This Non-provisional application claims priority under 35 U.S.C. § 119(a) on Patent Application No(s). 107116425 filed in Taiwan, Republic of China on May 15, 2018, the entire contents of which are hereby incorporated by reference.

### BACKGROUND

### Technology Field

This disclosure relates to an electronic writing board and, in particular, to an electronic writing board made of Cholesteric liquid crystals, which have low cost and low power consumption.

### Description of Related Art

The Cholesteric liquid crystals are made by adding chiral dopants into the

Nematic liquid crystals, so that the Nematic liquid crystals can have a spiral arrangement structure. When applying different voltages, the liquid crystal molecules can be arranged to reflect or transit light so as to provide different light transmissions, thereby achieving the desired displaying effect. In particular, when the liquid crystal molecules are arranged in the planar state, the light will be reflected to display the corresponding color. When the liquid crystal molecules are arranged in the focal conic state, a most part of the light will transit through the liquid crystal molecules and a miner part of the light will be scattered. When the liquid crystal molecules are arranged in the homeotropic state, the light will completely transit through the liquid crystal molecules.

Since the Cholesteric liquid crystal is in a stable state in both the planar state and the focal conic state, when the power is turned off and the voltage disappears, the Cholesteric liquid crystals can maintained in the original state to display the same image. Only when changing to another state and image, the voltage is applied again. The low power consumption and memory characteristics make the Cholesterol liquid crystals the first choice for the material of electronic books. Meanwhile, this display mechanism is less affected by the distance between the upper and lower plates, and has the potential and application to develop into a bistable flexible display. Compared with other types of liquid crystal displays, such as the TN type liquid crystal display, the Cholesteric liquid crystal display has the advantages of power saving, color display, dimmable, and application to a bistable flexible display, and it can be applied to many fields.

Up to now, the writing board made of Cholesteric liquid crystals usually adopts a flexible substrate (e.g. a plastic substrate) as a writing surface because the pressure written by the user must change the state of the Cholesteric liquid crystals. However, the process and production equipment for the flexible substrate are incompatible with the process and production equipment of the general display device. Therefore, it is an important subject to make the manufacture of the cholesterol liquid crystal writing board compatible with the current display device and still have a writing function, thereby simplifying the manufacturing process and reducing the cost of production machines.

### SUMMARY

An objective of this disclosure is to provide an electronic writing board having a novel structure, which can be easily manufactured and has lower cost of production machines. The present disclosure provides an electronic writing board, which comprises a first glass substrate, a second glass substrate and a Cholesteric liquid crystal layer. The first glass substrate has a writing surface, and the thickness thereof is between 0.1 mm and 0.35 mm. The second glass substrate is disposed opposite to the first glass substrate. The Cholesteric liquid crystal layer is disposed between the first glass substrate and the second glass substrate.

In one embodiment, the electronic writing board further comprises a first transparent conductive layer and a second transparent conductive layer. The first transparent conductive layer is disposed on a surface of the first glass substrate facing the Cholesteric liquid crystal layer, and the second transparent conductive layer is disposed on a surface of the second glass substrate facing the Cholesteric liquid crystal layer.

In one embodiment, the first transparent conductive layer is fully disposed on the surface of the first glass substrate facing the Cholesteric liquid crystal layer. The second transparent conductive layer comprises a plurality of electrode blocks arranged in an array, and the Cholesteric liquid crystal layer comprises a plurality of liquid crystal control areas. The electrode blocks are located corresponding to the liquid crystal control areas.

In one embodiment, the first transparent conductive layer comprises a plurality of first electrodes separately disposed along a first direction, the second transparent conductive layer comprises a plurality of second electrodes separately disposed along a second direction, and the first direction is different from the second direction.

In one embodiment, the Cholesteric liquid crystal layer comprises a plurality of liquid crystal control areas, and the first electrodes and the second electrodes are interlaced in a top-view direction of the writing surface for corresponding to the liquid crystal control areas.

In one embodiment, the first glass substrate is a light-permeable substrate, and the second glass substrate is a light reflective plate or a light absorption plate.

In one embodiment, the electronic writing board further comprises a back plate disposed on a surface of the second glass substrate away from the Cholesteric liquid crystal layer.

In one embodiment, the back plate is a light reflective plate or a light reflective layer.

In one embodiment, the back plate is a light absorption plate or a light absorption layer.

In one embodiment, the electronic writing board further comprises a transparent protective layer disposed on the writing surface.

In one embodiment, when the writing surface is pressed, at least a part of the Cholesteric liquid crystal layer is transited from a focal conic state to a planar state for displaying a writing trace.

In one embodiment, the writing trace is in a color corresponding to the electronic writing board.

In one embodiment, the electronic writing board further comprises a display control circuit electrically connected with the first transparent conductive layer and the second transparent conductive layer, and the Cholesteric liquid crystal layer comprises a plurality of liquid crystal control areas. The display control circuit outputs a display control signal to the first transparent conductive layer and the second transparent conductive layer for driving the corresponding liquid crystal areas to display an image.

As mentioned above, in the electronic writing board of this disclosure, the Cholesteric liquid crystal layer is disposed between the first glass substrate and the second glass substrate, the first glass substrate has a writing surface, and the thickness of the first glass substrate is between 0.1 mm and 0.35 mm. The electronic writing board of this disclosure has a novel structure. Since the thickness of first glass substrate is between 0.1 mm and 0.35 mm, it can have flexibility and a writing function. In addition, the first glass substrate having the writing surface can be manufactured by the process and production equipment of the glass substrate of the general display device, which means that the process and production equipment for the Cholesteric liquid crystal writing board of this disclosure can be compatible with the process and production equipment of the current display device. Accordingly, the manufacturing process of this disclosure is easier, and the cost of production machines can be reduced.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing an electronic writing board according to an embodiment of this disclosure;

FIG. 2 is a schematic diagram showing the structure of the electronic writing board of FIG. 1;

FIG. 3A is a partial schematic diagram of the electronic writing board according to another embodiment of this disclosure;

FIG. 3B is a top view of the first transparent conductive layer and the second transparent conductive layer of the electronic writing board of FIG. 3A;

FIG. 4A is a schematic diagram showing the structure of an electronic writing board according to another embodiment of this disclosure; and

FIG. 4B is a schematic diagram showing the structure of an electronic writing board according to another embodiment of this disclosure.

### DETAILED DESCRIPTION OF THE DISCLOSURE

The present disclosure will be apparent from the following detailed description, which proceeds with reference to the accompanying drawings, wherein the same references relate to the same elements.

To be noted, all directional indications (such as up, down, left, right, front, back, . . . ) in the embodiments of the present disclosure are only used to explain the relative positions and motions between the components in a specific posture (see the figures). If the specific posture changes, the directional indication will also change accordingly.

The electronic writing boards according to the following embodiments of the present disclosure utilize the characteristics of Cholesteric liquid crystals, and thus are bistable display devices. When the electronic writing board displays an image or a picture, no additional power is required. The image or picture will be retained all the time. Only when changing to another state or image, the additional power is applied. Thus, the electronic writing board is a low-cost and power-saving electronic device.

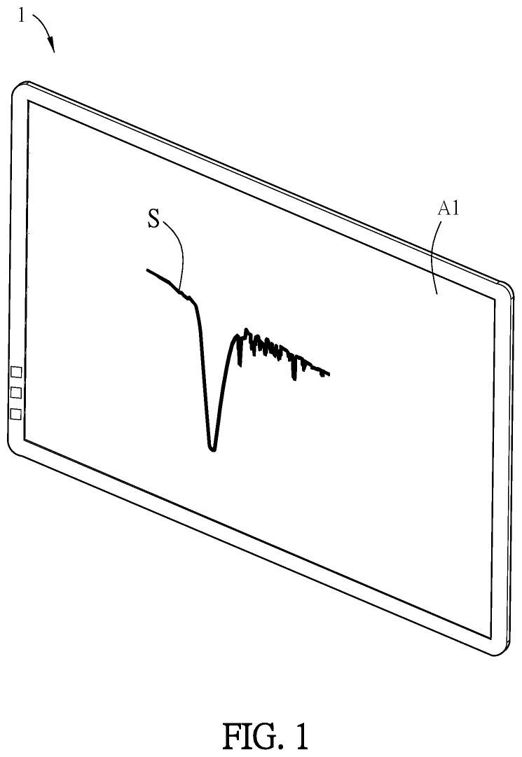

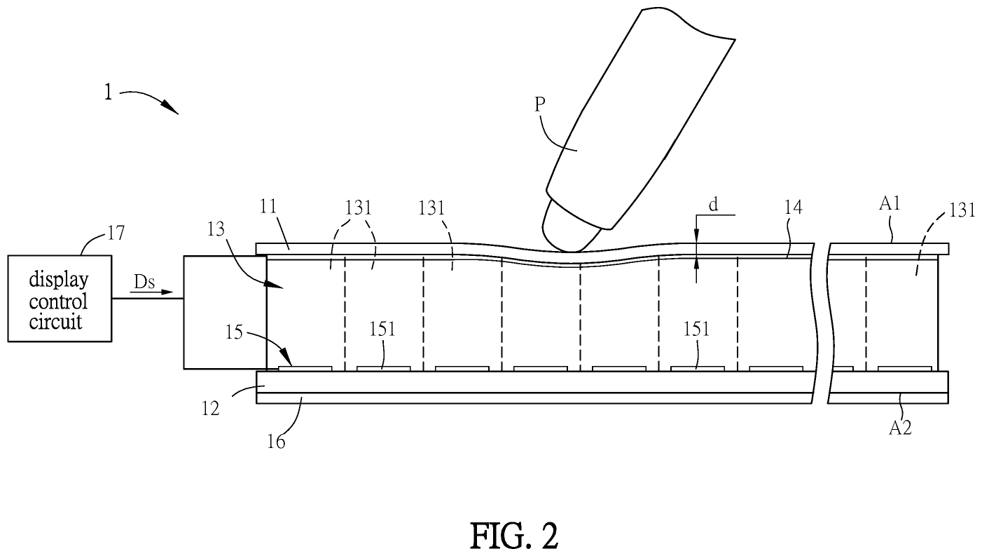

FIG. 1 is a schematic diagram showing an electronic writing board according to an embodiment of this disclosure, and FIG. 2 is a schematic diagram showing the structure of the electronic writing board of FIG. 1. The electronic writing board of this disclosure is, for example but not limited to, a mobile phone, a tablet, an electronic whiteboard, or any of other display devices capable of displaying an image. As shown in FIG. 1, the electronic writing board 1 of the present embodiment is exemplified by a large-sized electronic blackboard (or whiteboard) applied to a conference or teaching system, but the present disclosure is not limited thereto.

As shown in FIGS. 1 and 2, the electronic writing board 1 comprises a first glass substrate 11, a second glass substrate 12, and a Cholesteric liquid crystal layer 13. In this embodiment, the electronic writing board 1 further comprises a first transparent conductive layer 14, a second transparent conductive layer 15, a back plate 16, and a display control circuit 17.

The first glass substrate 11 is disposed opposite to the second glass substrate 12. The Cholesteric liquid crystal layer 13 comprises a plurality of Cholesteric liquid crystal molecules (not shown), and the Cholesteric liquid crystal layer 13 can be filled between the first glass substrate 11 and the second glass substrate 12. The electronic writing board 1 can further comprise a sealant (not shown) disposed between the first glass substrate 11 and the second glass substrate 12 for sealing the periphery of the first glass substrate 11 and the second glass substrate 12, thereby forming a space between the first glass substrate 11 and the second glass substrate 12. For example, the sealant can be a frame sealant. The first glass substrate 11, the second glass substrate 12 and the sealant can form an accommodating space for accommodating the filled Cholesteric liquid crystal molecules to form the Cholesteric liquid crystal layer 13. In this embodiment, the Cholesteric liquid crystal layer 13 comprises a plurality of liquid crystal control areas 131.

The first glass substrate 11 has a writing surface A1, which is the surface of the electronic writing board 1 facing to the user. The writing surface A1 can also be realized as a light input surface or a display surface. The user can write (press) on the writing surface A1 to generate the writing trace S (see FIG. 1). To be noted, the user can directly write (press) on the writing surface A1 to generate the writing trace S. Alternatively, another film can be disposed on the writing surface A1, and the user can write (press) on the film, and then the writing (pressing) force can be delivered to the writing surface A1 of the first glass substrate 11 to generate the writing trace S. In this embodiment, the writing surface A1 is the (upper) surface of the first glass substrate 11 away from the Cholesteric liquid crystal layer 13. In addition, the electronic writing board 1 further comprises a light output surface A2. In this embodiment, the light output surface A2 is the (lower) surface of the second glass substrate 12 away from the Cholesteric liquid crystal layer 13.

The electronic writing board 1 can correspondingly display a color. Specifically, the Cholesteric liquid crystal layer 13 of the electronic writing board 1 can be added with different amount of optical agent for providing the corresponding color, such as red (R), green (G) or blue (B). Accordingly, the corresponding displayed color of the electronic writing board 1 can be, for example but not limited to, red, green, blue or any of other visible light colors. The Cholesteric liquid crystals are made by adding the optical agent into the Nematic liquid crystals so as to achieve a special arrangement structure, and the Cholesteric liquid crystal molecules have several different steady states and transient states, such as the focal conic state, planar state and homeotropic state, under different voltage differences, physical pressures, and/or temperatures. Accordingly, the Cholesteric liquid crystal writing board can achieve the display or clearing function. Therefore, a part of the light can be reflected by the Cholesteric liquid crystals and/or a part of the light can pass through the Cholesteric liquid crystals by changing the axial directions of the spiral structure of the Cholesteric liquid crystals. That is, the display, writing, and even erasing functions of the electronic writing board 1 can be achieved by different light reflectance or transmittance of the cholesteric liquid crystal molecules in different states.

In this embodiment, the first glass substrate 11 and the second glass substrate 12 can be made of light-permeable materials, and the thickness d of the first glass substrate 11 is between 0.1 mm and 0.35 mm (0.1 mm≤d≤0.35 mm). Herein, the thickness d of the first glass substrate 11 is less than that of the second glass substrate 12. Of course, in other embodiments, the thickness of the first glass substrate 11 can be equal to or greater than that of the second glass substrate 12, and this disclosure is not limited thereto. Since the thickness d of the first glass substrate 11 is between 0.1 mm and 0.35 mm, the first glass substrate 11 can have the bendable characteristics. In practice, the general thicker glass substrate (e.g. 0.5˜1.5 mm) has higher hardness, so it is difficult to be bent or deformed. On the contrary, the first glass substrate 11 of this embodiment has a thickness d between 0.1 mm and 0.35 mm, so it can have the flexible property so as to achieve the desired writing function. When writing (pressing) on the writing surface A1 of the electronic writing board 1, the pressed portion will have a sunken shape, thereby shortening the distance between the first glass substrate 11 and the second glass substrate 12. The pressing force can also be delivered to the Cholesteric liquid crystal layer 13 so as to induce the transition of the Cholesteric liquid crystal molecules. The first glass substrate having the writing surface can be manufactured by the process and production equipment of the glass substrate of the general display device, which means that the process and production equipment for the electronic writing board 1 (the Cholesteric liquid crystal writing board) of this embodiment can be compatible with the process and production equipment of the current display device. Accordingly, the manufacturing process of the electronic writing board 1 is easier, and the cost of production machines can be reduced.

In some embodiments, the thickness of the first glass substrate 11 can be minimized to 0.1˜0.35 mm by, for example but not limited to, chemical mechanical planarization (CMP). In some embodiments, the thickness of the second glass substrate 12 can also be between 0.1 mm and 0.35 mm, so that the entire electronic writing board 1 can have better flexibility so as to form a curved surface writing board or display device.

Specifically, if the electronic writing board 1 of this embodiment is not pressed and not applied with power, the Cholesteric liquid crystal molecules of the Cholesteric liquid crystal layer 13 are arranged in the focal conic state. In this case, the incident light can mostly pass through the Cholesteric liquid crystal layer 13, and a few part of the incident light will be scattered. Accordingly, the user can view the background color of the electronic writing board 1 (e.g. black). As shown in FIG. 2, when the user writes on the electronic writing board 1 by finger, stylus, or other rigid object, the writing surface A1 of the first glass substrate 11 will be pressed to form the sunken portion, thereby reducing the distance between the first glass substrate 11 and the second glass substrate 12. The Cholesteric liquid crystal molecule(s) corresponding to the sunken portion can be transited from the original focal conic state to the planar state. In this case, the part of the incident light around the pressed portion (the sunken portion of the first glass substrate 11) can have Bragg reflection, and the reflected light (with a certain wavelength) can be outputted through the writing surface A1. Meanwhile, the pressed portion of the electronic writing board 1 can display the color of the reflected light (e.g. green) so as to display the writing trace S (see FIG. 1). As a result, when the user writes or draws on the electronic writing board 1 to generate the writing trace S, the writing trace S will show the color corresponding to the reflected light (the color corresponding to the electronic writing board 1). The detailed mechanism for generating the writing trace on the Cholesteric liquid crystal writing board can refer to U.S. Pat. No. 8,139,039 B2, and this and all other extrinsic materials discussed herein are incorporated by reference in their entirety.

The first transparent conductive layer 14 is disposed on a surface of the first glass substrate 11 facing the Cholesteric liquid crystal layer 13, and the second transparent conductive layer 15 is disposed on a surface of the second glass substrate 12 facing the Cholesteric liquid crystal layer 13. In this embodiment, the first transparent conductive layer 14 is disposed on the lower surface of the first glass substrate 11, and the second transparent conductive layer 15 is disposed on the upper surface of the second glass substrate 12. Herein, the first transparent conductive layer 14 can be a whole electrode layer, which is fully disposed at one side of the first glass substrate 11 facing the Cholesteric liquid crystal layer 13. The second transparent conductive layer 15 comprises a plurality of electrode blocks 151 arranged in an array. The second transparent conductive layer 15 is disposed at one side of the second glass substrate 12 facing the Cholesteric liquid crystal layer 13. The electrode blocks 151 are located corresponding to the liquid crystal control areas 131. Specifically, the electrode blocks 151 and the first transparent conductive layer 14 can form electrode pairs for controlling the corresponding liquid crystal control areas 131. Herein, the term “fully” indicates that the first transparent conductive layer 14 comprises a whole layer of common electrode, and the common electrode covers most of the surface of the first glass substrate 11 facing the Cholesteric liquid crystal layer 13. Each electrode block 151 of the second transparent conductive layer 15 can function as a pixel electrode, which can cooperate with the first transparent conductive layer 14 to control one corresponding liquid crystal control area 131. When the voltage signal is sent to the electrode block 151 to form a voltage difference between the electrode block 151 and the first transparent conductive layer 14, a corresponding electrode field can be induced to rotate the Cholesteric liquid crystal molecules in the corresponding liquid crystal control area 131. The first transparent conductive layer 14 and the second transparent conductive layer 15 can be made of, for example but not limited to, ITO (indium tin oxide) or IZO (indium zinc oxide), but this disclosure is not limited thereto.

The display control circuit 17 is electrically connected with the first transparent conductive layer 14 and the second transparent conductive layer 15. The display control circuit 17 can output a display control signal Ds to the first transparent conductive layer 14 and the electrode block 151 of the second transparent conductive layer 15 for driving the corresponding liquid crystal control area 131 to display image. In some embodiments, the display control circuit 17 can be, for example but not limited to, a scan driving circuit, a data driving circuit, and a timing control circuit, and the display control signal Ds can be, for example but not limited to, a scan signal, a data signal, and a common voltage circuit. The technology of outputting the control signal Ds from the display control circuit 17 to rotate the liquid crystal molecules for displaying image is a conventional art, and is not the feature of this disclosure. Those skilled persons in the art can find the detailed information thereof from the public references, so the detailed descriptions thereof will be omitted.

The back plate 16 is disposed on a surface of the second glass substrate 12 away from the Cholesteric liquid crystal layer 13. In this embodiment, the back plate 16 is disposed on the light output surface A2 of the second glass substrate 12. The back plate 16 can be a black light absorption plate or a black light absorption layer. Alternatively, the back plate 16 can also be a white light reflective plate or a white light reflective layer. If the back plate 16 is a black light absorption plate or a black light absorption layer, it can absorb the light passing through the light output surface A2, so that the electronic writing board 1 becomes a blackboard. In some embodiments, the black light absorption plate (or light absorption film) can be made of the material the same as the black matrix of the liquid crystal display device. If the back plate 16 is a white light reflective plate or a white light reflective layer, it can reflect the light passing through the light output surface A2, so that the electronic writing board 1 becomes a whiteboard. In some embodiments, the material of the white light reflective plate (or white light reflective film) can comprise metal, metal oxide, high-reflective paint (white paint), or their combinations, and this disclosure is not limited thereto. In other embodiments, the color of the back plate 16 is not limited to black or white and can be any of other colors or a combination of multiple colors.

In some embodiments, when the user presses a clear button (physical or virtual button) on the electronic writing board 1, the electronic writing board 1 can be switched to an all-clear mode. In the all-clear mode, the display control circuit 17 can output a voltage clear signal to the first transparent conductive layer 14 and all electrode blocks 151 of the second transparent conductive layer 15 for transiting the Cholesteric liquid crystal molecules of all liquid control areas 131 to the focal conic state, thereby clearing all writing trace S shown on the electronic writing board 1.

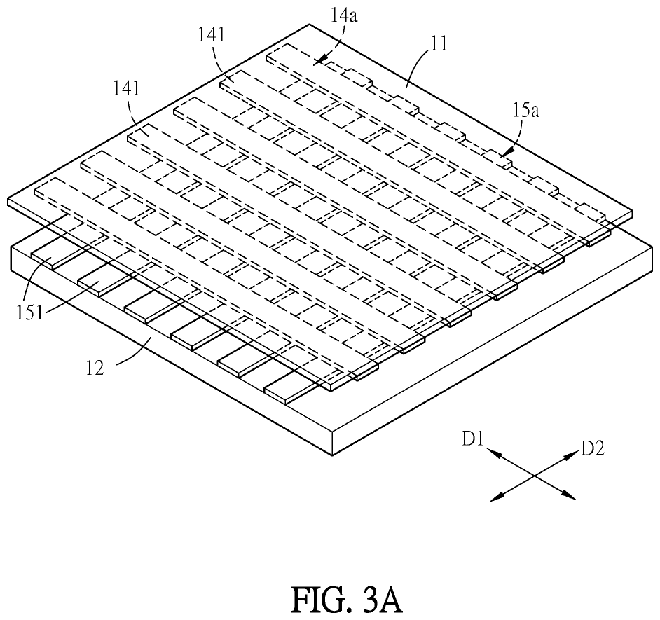

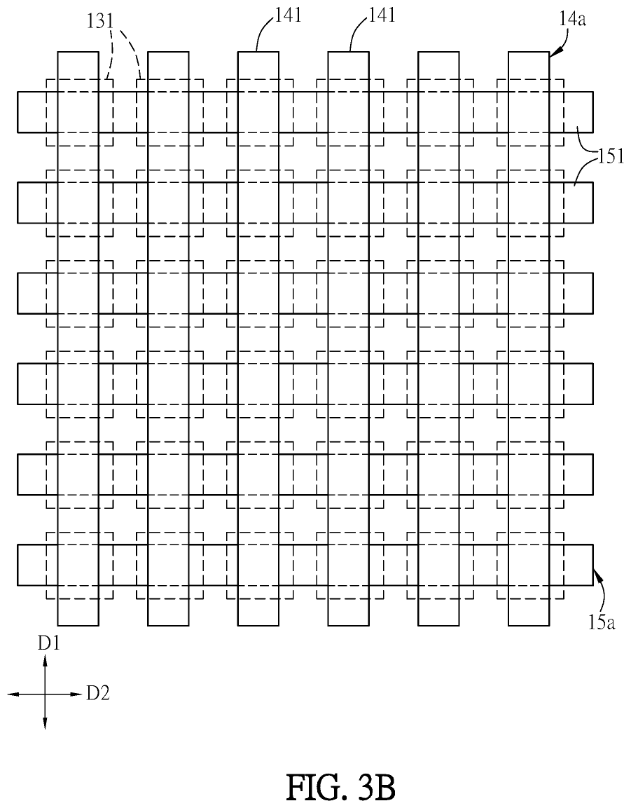

FIG. 3A is a partial schematic diagram of the electronic writing board according to another embodiment of this disclosure, and FIG. 3B is a top view of the first transparent conductive layer and the second transparent conductive layer of the electronic writing board of FIG. 3A. To be noted, FIG. 3A only shows the first glass substrate 11, the second glass substrate 12, the first transparent conductive layer 14a and the second transparent conductive layer 15a, and FIG. 3B only shows the first transparent conductive layer 14a, the second transparent conductive layer 15a, and the liquid control areas 131.

In another embodiment, as shown in FIGS. 3A and 3B, the first transparent conductive layer 14a comprises a plurality of first electrodes 141 separately disposed along a first direction D1, and the second transparent conductive layer 15a comprises a plurality of second electrodes 151 separately disposed along a second direction D2. The first direction D1 is different from the second direction D2. In this embodiment, an included angle between the first direction D1 and the second direction D2 can be, for example but not limited to, 90 degrees. When viewing from the top of the writing surface A1, the first electrodes 141 and the second electrodes 151 are interlaced for corresponding to the liquid crystal control areas 131 (see FIG. 3B). Accordingly, the display control circuit 17 (see FIG. 2) can also output the display control signal Ds to the first electrode 141 of the first transparent conductive layer 14a and the second electrode 151 of the second transparent conductive layer 15a for driving the liquid crystal control area 131 corresponding to the intersection thereof and thus displaying the image.

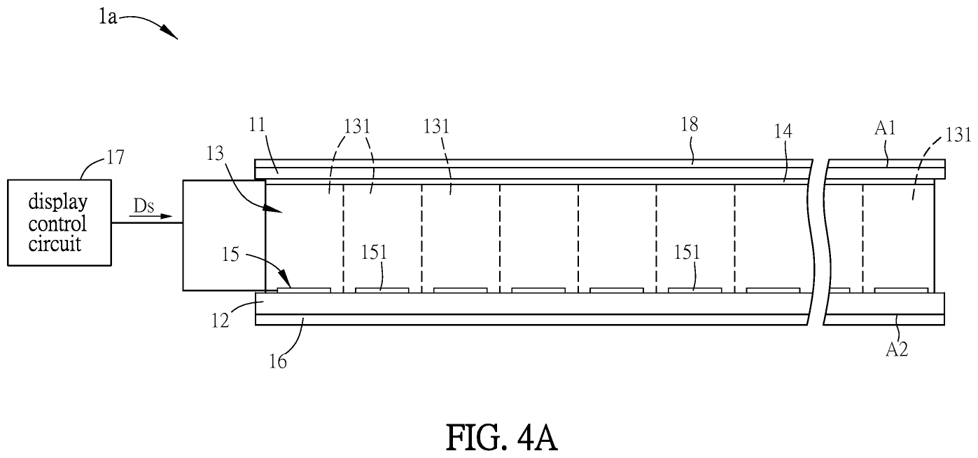

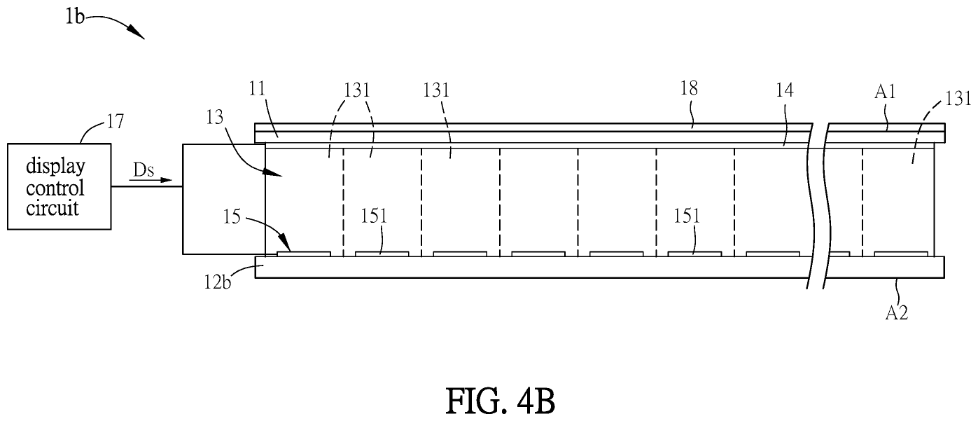

FIG. 4A is a schematic diagram showing the structure of an electronic writing board 1a according to another embodiment of this disclosure. The compositions and connections of the components of the electronic writing board 1a are mostly the same as those of the above-mentioned electronic writing board 1. Different from the previous embodiment, the electronic writing board 1a further comprises a transparent protective layer 18 disposed on the writing surface A1 of the first glass substrate 11 for protecting the first glass substrate 11. The transparent protective layer 18 can be, for example but not limited to, a hard coating with scratch resistance. This configuration can improve the durability of the electronic writing board 1a. In some embodiments, the transparent protective layer 18 can be an anti-reflective layer for reducing the reflection of light and thus increasing the transmittance of the first glass substrate 11. Alternatively, the transparent protective layer 18 can comprise multiple layers, such as a hard coating, an anti-reflective layer, and/or other protective films. This disclosure is not limited.

FIG. 4B is a schematic diagram showing the structure of an electronic writing board 1b according to another embodiment of this disclosure. The compositions and connections of the components of the electronic writing board 1b are mostly the same as those of the above-mentioned electronic writing board 1a. Different from the above-mentioned electronic writing board 1a, the electronic writing board 1b does not comprise the back plate 16. In the electronic writing board 1b, the first glass substrate 11 is a transparent substrate, but the second glass substrate 12b is a black light absorption plate or a white light reflective plate. In other words, the second glass substrate 12b of this embodiment has the functions of the second glass substrate 12 and the back plate 16 of the previous embodiment.

In summary, the Cholesteric liquid crystal layer is disposed between the first glass substrate and the second glass substrate, the first glass substrate has a writing surface, and the thickness of the first glass substrate is between 0.1 mm and 0.35 mm. The electronic writing board of this disclosure has a novel structure. Since the thickness of first glass substrate is between 0.1 mm and 0.35 mm, it can have flexibility and a writing function. In addition, the first glass substrate having the writing surface can be manufactured by the process and production equipment of the glass substrate of the general display device, which means that the process and production equipment for the Cholesteric liquid crystal writing board of this disclosure can be compatible with the process and production equipment of the current display device. Accordingly, the manufacturing process of this disclosure is easier, and the cost of production machines can be reduced.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. An electronic writing board, comprising:
a first glass substrate having a writing surface, wherein a thickness of the first glass substrate is between 0.1 mm and 0.35 mm;
a second glass substrate disposed opposite to the first glass substrate;
a Cholesteric liquid crystal layer disposed between the first glass substrate and the second glass substrate;
a first transparent conductive layer disposed on a surface of the first glass substrate facing the Cholesteric liquid crystal layer;
a second transparent conductive layer disposed on a surface of the second glass substrate facing the Cholesteric liquid crystal layer; and
a display control circuit electrically connected with the first transparent conductive layer and the second transparent conductive layer, wherein the Cholesteric liquid crystal layer comprises a plurality of liquid crystal control areas, and the display control circuit outputs a display control signal to the first transparent conductive layer and the second transparent conductive layer for driving the corresponding liquid crystal areas to display an image.

2. The electronic writing board according to claim 1, wherein the first transparent conductive layer is fully disposed on the surface of the first glass substrate facing the Cholesteric liquid crystal layer, and the second transparent conductive layer comprises a plurality of electrode blocks arranged in an array and located corresponding to the liquid crystal control areas.

3. The electronic writing board according to claim 1, wherein the first glass substrate is a light-permeable substrate, and the second glass substrate is a light reflective plate or a light absorption plate.

4. The electronic writing board according to claim 1, further comprising:
a back plate disposed on a surface of the second glass substrate away from the Cholesteric liquid crystal layer.

5. The electronic writing board according to claim 4, wherein the back plate is a light reflective plate or a light reflective layer.

6. The electronic writing board according to claim 4, wherein the back plate is a light absorption plate or a light absorption layer.

7. The electronic writing board according to claim 1, further comprising:
a transparent protective layer disposed on the writing surface.

8. An electronic writing board, comprising:
a first glass substrate having a writing surface, wherein a thickness of the first glass substrate is between 0.1 mm and 0.35 mm;
a second glass substrate disposed opposite to the first glass substrate; and
a Cholesteric liquid crystal layer disposed between the first glass substrate and the second glass substrate;
wherein when the writing surface is pressed, at least a part of the Cholesteric liquid crystal layer is transited from a focal conic state to a planar state for displaying a writing trace.

9. The electronic writing board according to claim 8, wherein the writing trace is in a color corresponding to the electronic writing board.

10. An electronic writing board, comprising:
a first glass substrate having a writing surface, wherein a thickness of the first glass substrate is between 0.1 mm and 0.35 mm;
a second glass substrate disposed opposite to the first glass substrate;
a Cholesteric liquid crystal layer disposed between the first glass substrate and the second glass substrate;
a first transparent conductive layer disposed on a surface of the first glass substrate facing the Cholesteric liquid crystal layer; and
a second transparent conductive layer disposed on a surface of the second glass substrate facing the Cholesteric liquid crystal layer;
wherein the first transparent conductive layer comprises a plurality of first electrodes separately disposed along a first direction, the second transparent conductive layer comprises a plurality of second electrodes separately disposed along a second direction, and the first direction is different from the second direction.

11. The electronic writing board according to claim 8, wherein the Cholesteric liquid crystal layer comprises a plurality of liquid crystal control areas, and the first electrodes and the second electrodes are interlaced in a top-view direction of the writing surface for corresponding to the liquid crystal control areas.
